(19) United States
(12) Patent Application Publication
(10) Pub. No.: US 2015/0375081 A1
(43) Pub. Date: Dec. 31, 2015

(54) EXERCISE INFORMATION PROVIDING METHOD AND EXERCISE INFORMATION PROVIDING SYSTEM

(71) Applicant: SEIKO EPSON CORPORATION, Tokyo (JP)

(72) Inventor: Tsuyoshi ITO, Suwa-shi (JP)

(21) Appl. No.: 14/746,064

(22) Filed: Jun. 22, 2015

(30) Foreign Application Priority Data
Jun. 26, 2014 (JP) 2014-131611

(51) Int. Cl. A63B 69/36; G09B 5/02; G09B 19/00

(52) U.S. Cl. CPC A63B 69/3632; G09B 19/0038; G09B 5/02; A63B 69/3641; A63B 2225/50

(57) ABSTRACT

An exercise information providing method includes acquiring first exercise information based on an output from a detecting device output when a user performs exercise in a first environment and first environment information concerning the first environment, associating the first exercise information and the first environment information and accumulating the first exercise information and the first environment information as first associated information, and outputting the first associated information to a second environment.

### BACKGROUND

1. Technical Field

The present invention relates to an exercise information providing method and an exercise information providing system.

2. Related Art

There are various sports including motions of swinging exercise instruments such as golf, tennis, table tennis, baseball, and softball. For the improvement of these sports, learning of ideal swings of the exercise instruments considered to be one of important factors.

JP-A-2003-15519 (Patent Literature 1) discloses a swing teaching system with which a student can obtain, concerning swing images of the student, appropriate advices and answers to questions from an instructor or the like through a network.

In the swing teaching system of Patent Literature 1, since the advices are created on the basis of the swing image, it is not easy to compare the swing images with other images (e.g., swing images in the past).

### SUMMARY

An advantage of some aspects of the invention is to provide an exercise information providing method and an exercise information providing system that can provide a user with exercise information concerning a motion of swinging an exercise instrument.

The invention can be implemented as the following aspects or application examples.

### Application Example 1

An exercise information providing method according to this application example is an exercise information providing method including: acquiring first exercise information based on an output from a detecting device output when a user performs exercise in a first environment and first environment information concerning the first environment; associating the first exercise information and the first environment information and accumulating the first exercise information and the first environment information as first associated information; and outputting the first associated information to a second environment.

The detecting device may include an inertial sensor such as an acceleration sensor or an angular velocity sensor.

According to this application example, since the first exercise information in the first environment is acquired using the detecting device such as the inertial sensor, it is possible to acquire information that is more easily compared with information concerning the exercise acquired in another scene (the second environment) than images and videos of the exercise. Since the first associated information obtained by associating the first exercise information and the first environment information is output in the second environment, it is possible to realize the exercise information providing method that can provide the user with the information concerning the exercise even in a different scene (the second environment).

### Application Example 2

An exercise information providing method according to this application example is an exercise information providing method including: acquiring first exercise information based on an output from a detecting device output when a user performs exercise in a first environment and first environment information concerning the first environment; associating the first exercise information and the first environment information and accumulating the first exercise information and the first environment information as first associated information; acquiring second exercise information based on an output from the detecting device output when the user performs exercise in a second environment and second environment information concerning the second environment; associating the second exercise information and the second environment information and accumulating the second exercise information and the second environment information as second associated information; and outputting the first associated information and the second associated information.

According to this application example, since the first exercise information and the second exercise information acquired in the different scenes are output, it is possible to realize the exercise information providing method with which pieces of exercise information acquired in the different scenes are easily compared.

### Application Example 3

In the exercise information providing method described above, the first exercise information included in the first associated information and the second exercise information included in the second associated information may be compared to output a comparison result.

According to this application example, since the comparison result of the first exercise information and the second exercise information is output, it is possible to realize the exercise information providing method with which exercise information acquired in another scene and new exercise information are easily compared.

### Application Example 4

In the exercise information providing method described above, the first environment information may include at least one of position information, time information, and event information obtained when the exercise is performed.

### Application Example 5

In the exercise information providing method described above, the second environment information may include at least one of position information, time information, and event information obtained when the exercise is performed.

According to these application examples, it is possible to accumulate useful information concerning an environment in which the user performs exercise.

### Application Example 6

In the exercise information providing method described above, the second environment may be a place different from the first environment.

According to this application example, it is possible to realize the exercise information providing method that can provide the user with information concerning exercise even in different scenes or the exercise information providing method with which pieces of exercise information acquired in different scenes are easily compared.

### Application Example 7

In the exercise information providing method described above, the exercise may be exercise performed using an exercise instrument, and information concerning the exercise instrument may be output to the second environment on the basis of the first exercise information.

### Application Example 8

In the exercise information providing method described above, the second environment may be a shop that sells the exercise instrument.

According to these application examples, the user can quickly purchase an exercise instrument suitable for the user based on the first exercise information and the information concerning the exercise instrument.

### Application Example 9

In the exercise information providing method described above, each of the first environment and the second environment may be any one of a game venue, a practice area, a tournament, a school, and a shop.

### Application Example 10

An exercise information providing system according to this application example is an exercise information providing system including: an acquiring unit configured to acquire first exercise information based on an output from a detecting device output when a user performs exercise in a first environment and first environment information concerning the first environment; an accumulating unit configured to associate the first exercise information and the first environment information and accumulate the first exercise information and the first environment information as first associated information; and an output unit configured to output the first associated information to a second environment.

According to this application example, since the first exercise information in the first environment is acquired using the detecting device such as an inertial sensor, it is possible to acquire information that is more easily compared with information concerning the exercise acquired in another scene (the second environment) than images and videos of the exercise. Since the first associated information obtained by associating the first exercise information and the first environment information is output in the second environment, it is possible to realize the exercise information providing system that can provide the user with the information concerning the exercise even in a different scene (the second environment).

### Application Example 11

An exercise information providing system according to this application example is an exercise information providing system including: an acquiring unit configured to acquire first exercise information based on an output from a detecting device output when a user performs exercise in a first environment, first environment information concerning the first environment, second exercise information concerning exercise performed by the user in a second environment, and second environment information concerning the second environment; an accumulating unit configured to associate the first exercise information and the first environment information and accumulate the first exercise information and the first environment information as first associated information and associate the second exercise information and the second environment information and accumulate the second exercise information and the second environment information as second associated information; and an output unit configured to output the first associated information and the second associated information.

According to this application example, since the first exercise information and the second exercise information acquired in the different scenes are output, it is possible to realize the exercise information providing system with which pieces of exercise information acquired in different scenes are easily compared.

### Application Example 12

The exercise information providing system described above may further include: a terminal device including the acquiring unit; and a server device including the accumulating unit and the output unit.

According to this application example, it is possible to realize the exercise information providing system that can collectively manage the first exercise information and the environment information in the server device including the accumulating unit and an access to the exercise information providing system from the terminal device is easy.

### BRIEF DESCRIPTION OF THE DRAWINGS

The invention will be described with reference to the accompanying drawings, wherein like numbers reference like elements.

FIG. 1 is a diagram for explaining an overview of an exercise information providing system according to a first embodiment.

FIG. 2 is a diagram showing an example of a device position and a direction of a detecting device.

FIG. 3 is a block diagram showing a configuration example of an exercise information providing system according to the first embodiment.

FIG. 4 is a block diagram showing a configuration example of an exercise information providing system according to a second embodiment.

FIG. 5 is a block diagram showing a configuration example of an exercise information providing system according to a third embodiment.

FIG. 6 is a flowchart for explaining an overview of an information providing method according to the first embodiment.

FIG. 7 is a flowchart for explaining an overview of an information providing method according to the second embodiment.

FIG. 8 is a table showing an overview of use examples.

FIG. 9 is a diagram showing a display example of first exercise information and second exercise information.

FIGS. 10A and 10B are diagrams showing display examples displayed when exercise instrument information is extracted.

### DESCRIPTION OF EXEMPLARY EMBODIMENTS

Exemplary embodiments of the invention are explained in detail below with reference to the drawings. The drawings referred to below are drawings for convenience of explanation. Note that the embodiments explained below do not unduly limit contents of the invention described in the appended claims. Not all of components explained below are essential constituent elements of the invention.

In the following explanation, a motion (an example of exercise) of swinging a golf club (an example of an exercise instrument) is explained as an example. Note that the exercise instrument is not limited to the golf club and may be instruments used for hitting balls such as a tennis racket, a table tennis racket, a baseball bat, a softball bat, and a hockey stick.

### 1. Exercise Information Providing System

### 1-1. Overview of a Swing Supporting System

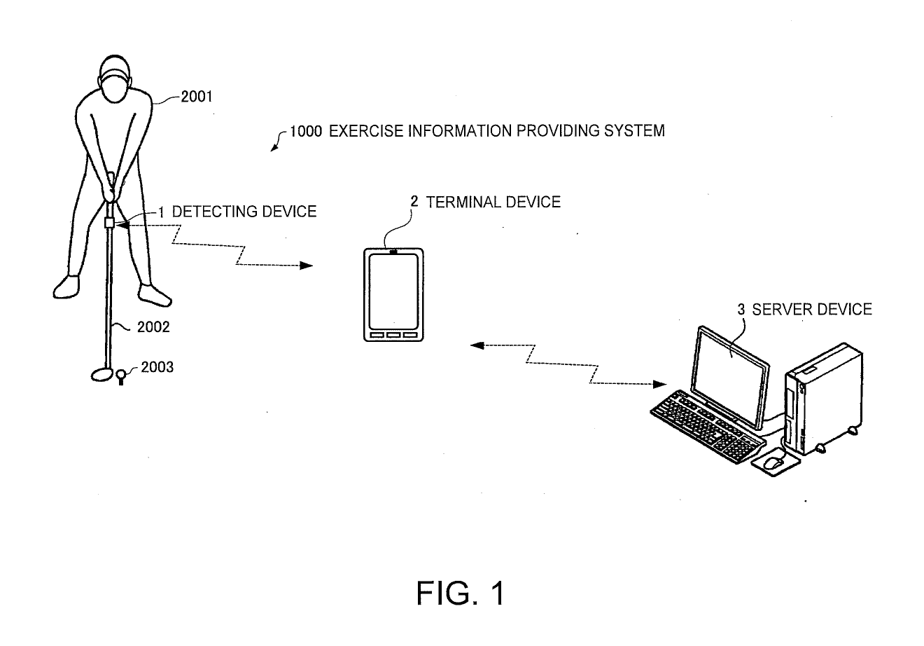

FIG. 1 is a diagram for explaining an overview of an exercise information providing system 1000 according to a first embodiment. The exercise information providing system 1000 in this embodiment includes a detecting device 1, a terminal device 2, and a server device 3.

The detecting device 1 detects a motion of a user 2001 swinging a golf club 2002 (an example of an exercise instrument).

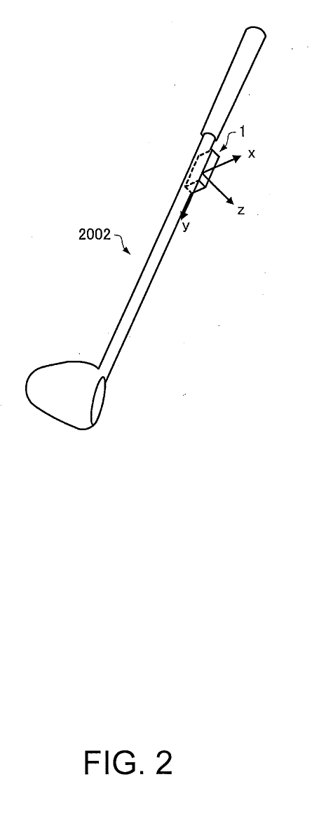

FIG. 2 is a diagram showing an example of a device position and a direction of the detecting device 1. The detecting device 1 is an inertial sensor capable of measuring accelerations generated in axial directions of three axes and angular velocities generated around the three axes. The detecting device 1 is mounted on the golf club 2002.

In this embodiment, as shown in FIG. 2, the detecting device 1 is attached to a part of a shaft of the golf club 2002 with one axis of three detection axes (an x axis, a y axis, and a z axis), for example, the y axis set in a major axial direction of the shaft. Desirably, the detecting device 1 is attached to a position near a grip section to which a shock during ball hitting is less easily transmitted and a centrifugal force is not applied during a swing. The shaft is a portion of a grip excluding a head of the golf club 2002 and includes the grip section.

The user 2001 performs a swing motion for hitting a golf ball 2003 according to a procedure determined in advance.

The terminal device 2 acquires information concerning the swing of the golf club 2002 (the exercise instrument) by the user 2001 using data detected by the detecting device 1. The terminal device 2 outputs information output from the server device 3. Note that one of the terminal device 2 and the server device 3 may perform at least a part of various arithmetic operations concerning the swing of the golf club 2002 (the exercise instrument) by the user 2001.

The server device 3 includes an accumulating unit 310 (explained below) that stores first exercise information (explained below), which is information concerning the swing by the user 2001.

Note that communication between the terminal device 2 and the detecting device 1 may be radio communication or may be wired communication. Communication between the terminal device 2 and the server device 3 may be radio communication or may be wired communication.

### 1-2. Configuration of an Exercise Information Providing System According to the First Embodiment

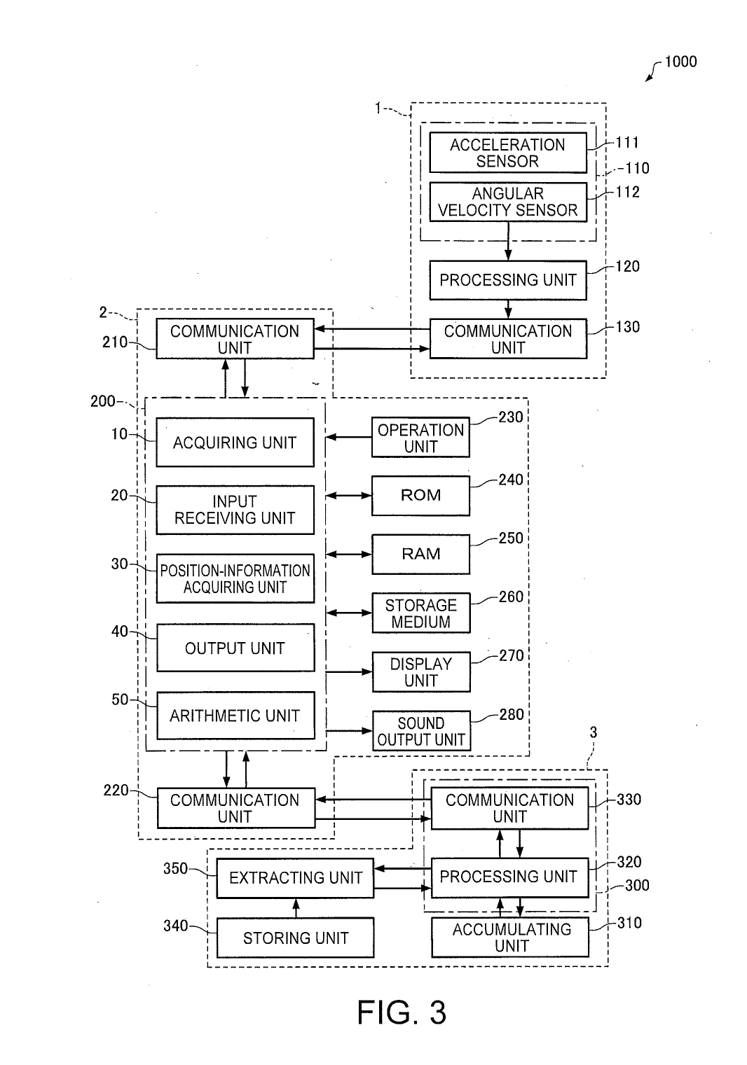

FIG. 3 is a block diagram showing a configuration example of the exercise information providing system 1000 according to the first embodiment.

The detecting device 1 in this embodiment includes a detecting unit 110, a processing unit 120, and a communication unit 130.

The detecting unit 110 may include, for example, an inertial sensor. The inertial sensor is a sensor that detects a physical quantity, a physical phenomenon, or the like (acceleration, an inclination angle, a shock, vibration, rotation, etc.) using inertia. As the inertial sensor, for example, an acceleration sensor, an angular velocity sensor, or the like can be adopted. In this embodiment, the detecting unit 110 includes an acceleration sensor 111 and an angular velocity sensor 112.

The acceleration sensor 111 measures accelerations respectively generated in three axial directions crossing one another (ideally, orthogonal to one another) and outputs a digital signal (acceleration data) corresponding to the magnitudes and the directions of the measured three-axis accelerations.

The angular velocity sensor 112 measures angular velocities respectively generated around three axes crossing one another (ideally, orthogonal to one another) and outputs a digital signal (angular velocity data) corresponding to the magnitudes and the directions of the measured three-axis angular velocities.

The processing unit 120 receives the acceleration data and the angular velocity data respectively from the acceleration sensor ill and the angular velocity sensor 112, adds time information to the acceleration data and the angular velocity data, stores the acceleration data and the angular velocity data in a not-shown storing unit, adds time information to the stored measurement data (the acceleration data and the angular velocity data) to generate packet data conforming to a format for communication, and outputs the packet data to the communication unit 130.

The acceleration sensor 111 and the angular velocity sensor 112 are ideally attached to the detecting device 1 such that the three axes thereof coincide with three axes (an x axis, a y axis, and a z axis) of an orthogonal coordinate system (a sensor coordinate system) defined with respect to the detecting device 1. However, actually, an error of an attachment angle occurs. Therefore, the processing unit 120 performs, using correction parameters calculated in advance according to the attachment angle error, processing for converting the acceleration data and the angular velocity data into data of an xyz coordinate system.

Further, the processing unit 120 performs temperature correction processing for the acceleration sensor 111 and the angular velocity sensor 112. Note that a function of temperature correction may be incorporated in the acceleration sensor 111 and the angular velocity sensor 112.

Note that the acceleration sensor 111 and the angular velocity sensor 112 may be sensors that output an analog signal. In this case, the processing unit 120 only has to A/D-convert an output signal of the acceleration sensor 111 and an output signal of the angular velocity sensor 112 to generate measurement data (acceleration data and angular velocity data) and generate packet data for communication using the measurement data.

The communication unit 130 performs, for example, processing for transmitting the packet data received from the processing unit 120 to the terminal device 2 as first exercise information or second exercise information, which is information concerning a swing of the user 2001 swinging the exercise instrument (the golf club 2002) and processing for receiving a control command from the terminal device 2 and sending the control command to the processing unit 120. The processing unit 120 performs various kinds of processing corresponding to the control command.

The terminal device 2 in this embodiment includes a processing unit 200, a communication unit 210, a communication unit 220, an operation unit 230, a ROM 240, a RAM 250, a storage medium 260, a display unit 270, and a sound output unit 280. The terminal device 2 may be, for example, a portable device such as a smart phone or a personal computer (PC).

The communication unit 210 performs, for example, processing for receiving packet data transmitted from the detecting device 1 and sending the packet data to the processing unit 200 and processing for transmitting a control command received from the processing unit 200 to the detecting device 1.

The communication unit 220 performs, for example, processing for receiving packet data transmitted from the server device 3 and sending the packet data to the processing unit 200 and processing for transmitting a control command received from the processing unit 200 to the server device 3.

The operation unit 230 performs processing for acquiring operation data from the user 2001 and sending the operation data to the processing unit 200. The operation unit 230 may be, for example, a touch panel display, buttons, keys, or a microphone.

The ROM 240 has stored therein computer programs for the processing unit 200 to perform various kinds of calculation processing and control processing and various computer programs, data, and the like for realizing an application function.

The RAM 250 is used as a work area of the processing unit 200. The RAM 250 is a storing unit that temporarily stores, for example, the computer programs and the data read out from the ROM 240, data input from the operation unit 230, and results of arithmetic operations executed by the processing unit 200 according to the various computer programs.

The storage medium 260 is a nonvolatile storing unit that stores data that needs to be stored for a long period among data generated by the processing of the processing unit 200. The storage medium 260 may store, for example, computer programs for the processing unit 200 to perform various kinds of calculation processing and control processing and various computer programs and data for realizing application functions.

The display unit 270 displays a processing result of the processing unit 200 as characters, a graph, a table, an animation, and other images. The display unit 270 may be, for example, a CRT, a LCD, a touch panel display, or an HMD (head mounted display). Note that the functions of the operation unit 230 and the display unit 270 may be realized by one touch panel display.

The sound output unit 280 outputs the processing result of the processing unit 200 as sound such as voice or buzzer sound. The sound output unit 280 may be, for example, a speaker or a buzzer.

The processing unit 200 performs, according to the computer programs stored in the ROM 240 or the storage medium 260 or computer programs received from a server via a network and stored in the RAM 250 or the storage medium 260, processing for transmitting control commands to the detecting device 1 and the server device 3, various kinds of calculation processing for data received from the detecting device 1 via the communication unit 210, various kinds of calculation processing for data received from the server device 3 via the communication unit 220, and other various kinds of control processing.

In particular, in this embodiment, the processing unit 200 executes a pertinent program (an exercise information providing program) to thereby function as an acquiring unit 10, an input receiving unit 20, a position-information acquiring unit 30, an output unit 40, and an arithmetic unit 50. The information providing program may be realized as a computer program for causing a computer to execute a procedure performed by at least any one of the acquiring unit 10, the input receiving unit 20, the position-information acquiring unit 30, the output unit 40, and the arithmetic unit 50.

The acquiring unit 10 acquires the first exercise information, which is the information concerning the swing of the user 2001, from the detecting device 1 that detects a motion of the user 2001 swinging the exercise instrument (the golf club 2002) (hereinafter sometimes simply described as “swing”). In this embodiment, the acquiring unit 10 acquires the first exercise information from the detecting device 1 via the communication unit 210.

The input receiving unit 20 receives an input of operation data from the operation unit 230. The input receiving unit 20 receives inputs of a command corresponding to a request of the user 2001 and various kinds of information such as environment information (explained below).

The position-information acquiring unit 30 acquires position information, which is information concerning the position of the terminal device 2. The position-information acquiring unit 30 may acquire the position information on the basis of a satellite signal from a positioning satellite. The positioning satellite may be, for example, a GPS (Global Positioning System) satellite. With such a configuration, the position-information acquiring unit 30 acquires the position information on the basis of the satellite signal from the positioning satellite. Therefore, it is possible to accurately acquire the position information. The position information acquired by the position-information acquiring unit 30 is an example of environment information (explained below). In a golf course, a carry of a hit ball may be estimated on the basis of position information during a swing.

The output unit 40 causes the display unit 270 and the sound output unit 280 to output various kinds of information. The output unit 40 may cause the display unit 270 to output the first exercise information output from the server device 3. The output unit 40 may process the first exercise information output from the server device 3 and cause the display unit 270 to output the first exercise information.

The server device 3 in this embodiment includes an output unit 300, the accumulating unit 310, a storing unit 340, and an extracting unit 350.

The accumulating unit 310 associates the first exercise information acquired by the acquiring unit 10 and environment information concerning a scene (a first environment) in which the first exercise information is acquired and accumulates the first exercise information and the environment information as first associated information. The accumulating unit 310 stores a plurality of kinds of the first exercise information and the environment information respectively associated with the first exercise information. As the environment information, for example, position information concerning a game venue such as a golf course, a practice area, a school, and a shop that sells golf gears, time information, and event information such as a tournament and a practice round of the tournament may be adopted.

The output unit 300 outputs, according to a request of the user 2001, the first associated information accumulated in the accumulating unit 310 to a second environment. For example, the first environment is the practice area and the second environment is the shop. In the example shown in FIG. 3, the output unit 300 includes a processing unit 320 and a communication unit 330.

The processing unit 320 stores the first exercise information in a not-shown storing unit from the accumulating unit 310, generates packet data conforming to a format for communication from the stored first exercise information, and outputs the packet data to the communication unit 330. The processing unit 320 may receive a command concerning a request of the user 2001 from the terminal device 2 and extract, on the basis of the received command, at least a part of the plurality of kinds of first exercise information accumulated in the accumulating unit 310.

The communication unit 330 performs, for example, processing for transmitting the packet data received from the processing unit 320 to the terminal device 2 and processing for receiving a control command from the terminal device 2 and sending the control command to the processing unit 320. The processing unit 320 performs various kinds of processing corresponding to the control command.

Note that the “output unit” in the invention may be equivalent to the output unit 300 or may be equivalent to a component including the output unit 300 and the output unit 40. For example, the first exercise information output by the output unit 300 may be output to the display unit 270 by the output unit 40.

The exercise information providing system 1000 according to this embodiment acquires the first exercise information in the first environment using the detecting device 1 such as the inertial sensor. Therefore, it is possible to acquire information that is more easily compared with information concerning exercise acquired in another scene (the second environment) than images and videos of the exercise. The exercise information providing system 1000 according to this embodiment outputs, according to a request of the user 2001, the first associated information obtained by associating the first exercise information and first environment information accumulated in the accumulating unit 310. Therefore, it is possible to realize the exercise information providing system 1000 that can provide the user 2001 with information concerning the motion of swinging the exercise instrument (the golf club 2002) even in a different scene (the second environment).

In the exercise information providing system 1000 according to this embodiment, the acquiring unit 10 may acquire, from the detecting device 1, the second exercise information, which is information concerning a new swing in another scene (the second environment) by the user 2001, and environment information concerning the second environment, and accumulate, in the server device 3, second associated information obtained by associating the second exercise information and the environment information concerning the second environment. The output unit 40 may output, according to a request of the user 2001, the first associated information including the first exercise information accumulated in the accumulating unit 310 and the second associated information including the second exercise information acquired by the acquiring unit 10. For example, the acquiring unit 10 acquires first associated information obtained by associating first exercise information concerning a swing in a golf course serving as the first environment and location information concerning the golf course and second associated information obtained by associating second exercise information concerning a swing in a practice area serving as the second environment and location information concerning the practice area and accumulates the information in the server device 3.

According to this embodiment, for example, the first exercise information concerning the swing in the golf course and the second exercise information concerning the swing in the practice area are output. Therefore, it is possible to realize the exercise information providing system 1000 with which kinds of information concerning swings acquired in different scenes are easily compared.

In the exercise information providing system 1000 according to this embodiment, the acquiring unit 10 may acquire, from the detecting device 1, the second exercise information, which is information concerning a new swing in another scene (the second environment) by the user 2001, and environment information concerning the second environment. The output unit 40 may compare, according to a request of the user 2001, the first exercise information and the second exercise information accumulated in the accumulating unit 310 and output a comparison result. For example, the output unit 40 may output a difference between the first exercise information and the second exercise information (e.g., a difference between head speed maximum values and a difference between angles of a face surface during impact).

According to this embodiment, the comparison result of the first exercise information and the second exercise information is output. Therefore, it is possible to realize the exercise information providing system 1000 with which information concerning a swing acquired in another scene and information concerning a new swing are easily compared. For example, first exercise information concerning a swing in a golf course serving as the first environment and environment information concerning the golf course and second exercise information concerning a swing in a practice area serving as the second environment and environment information concerning the practice area are accumulated in the server device 3. A difference between the first exercise information and the second exercise information is output to the user. Consequently, the user can recognize whether a difference occurs in the swings according to the different scenes (the golf course and the practice area).

The exercise information providing system 1000 according to this embodiment may further include the arithmetic unit 50 that indexes the information concerning the swing of the user 2001 acquired from the detecting device 1 and generates at least one of the first exercise information and the second exercise information.

As the index concerning the swing calculated by the arithmetic unit 50, for example, a maximum value of head speed during a swing period, a maximum value of grip speed during the swing period, timing when the grip speed takes the maximum value (grip deceleration timing) based on timing of impact, and a change amount of a rotation angle of a shaft axis during the swing period (shaft rotation) can be adopted.

According to this embodiment, compared with when the information is not indexed, it is possible to acquire information that is easily compared with information concerning a swing acquired in another scene.

The exercise information providing system 1000 according to this embodiment may further include the storing unit 340 that stores, concerning each of a plurality of exercise instruments (e.g., golf clubs), exercise instrument information, which is information concerning the exercise instrument (the golf club), and the extracting unit 350 that extracts the exercise instrument information from the storing unit 340 on the basis of the first exercise information accumulated in the accumulating unit 310. As the exercise instrument information, for example, a number, a manufacturer, and a serial number of the golf club 2002 can be adopted. The extracting unit 350 may extract the exercise instrument information on the basis of the first exercise information and information concerning a purchase purpose of the exercise instrument (the golf club) (which may be, for example, input from the operation unit 230 by the user 2001). In the example shown in FIG. 3, the storing unit 340 and the extracting unit 350 are provided in the server device 3. Note that at least one of the storing unit 340 and the extracting unit 350 may be provided in the terminal device 2. The exercise instrument information extracted by the extracting unit 350 may be output to the display unit 270 by the output unit 40.

According to this embodiment, the exercise instrument information is extracted from the storing unit 340 on the basis of the first exercise information accumulated in the accumulating unit 310. Therefore, for example, it is possible to extract, on the basis of a tendency of the swing of the user 2001, information concerning an exercise instrument suitable for the swing of the user 2001. For example, exercise instrument information suitable for the user is extracted on the basis of first swing information acquired in a practice area serving as the first environment and transmitted to a golf shop serving as the second environment. Consequently, the user can quickly purchase a golf club suitable for the user.

As shown in FIG. 3, the exercise information providing system 1000 according to this embodiment includes the terminal device 2 including the acquiring unit 10 and the arithmetic unit 50 and the server device 3 including the accumulating unit 310. Consequently, the first exercise information and the environment information can be collectively managed by the server device 3 including the accumulating unit 310. It is possible to realize the exercise information providing system 1000 easily accessed from the terminal device 2.

### 1-3. Configuration of an Exercise Information Providing System According to a Second Embodiment

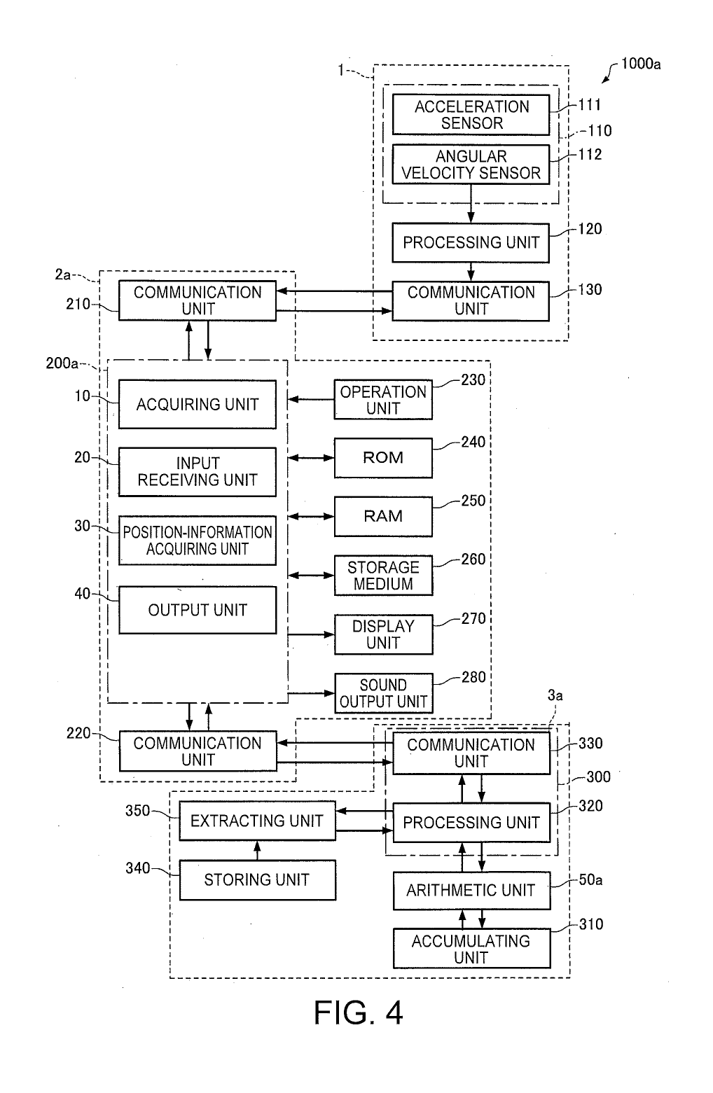

FIG. 4 is a block diagram showing a configuration example of an exercise information providing system 1000a according to a second embodiment. Components same as the components of the exercise information providing system 1000 according to the first embodiment are denoted by the same reference numerals and signs and detailed explanation of the components is omitted.

The exercise information providing system 1000 according to this embodiment includes the detecting device 1, a terminal device 2a, and a server device 3a. The exercise information providing system 1000a according to this embodiment is different from the exercise information providing system 1000 according to the first embodiment in that an arithmetic unit 50a is provided in the server device 3a.

The arithmetic unit 50a indexes the information concerning the swing of the user 2001 (at least one of first exercise information and second exercise information) acquired from the detecting device 1 and generates at least one of the first exercise information and the second exercise information. In this embodiment, the arithmetic unit 50a receives, via the processing unit 320, the information concerning the swing of the user 2001 (at least one of the first exercise information and the second exercise information) acquired from the detecting device 1. The first exercise information and the second exercise information generated by the arithmetic unit 50a may be stored in the accumulating unit 310.

As shown in FIG. 4, the exercise information providing system 1000a according to this embodiment includes the terminal device 2a including the acquiring unit 10 and the server device 3a including the accumulating unit 310 and the arithmetic unit 50a. Consequently, the first exercise information and environment information can be collectively managed by the server device 3a including the accumulating unit 310. It is possible to realize the exercise information providing system 1000a easily accessed from the terminal device 2a.

The exercise information providing system 1000a according to the second embodiment attains effects same as the effects of the exercise information providing system 1000 according to the first embodiment because of the same reason.

### 1-4. Configuration of an Exercise Information Providing System According to a Third Embodiment

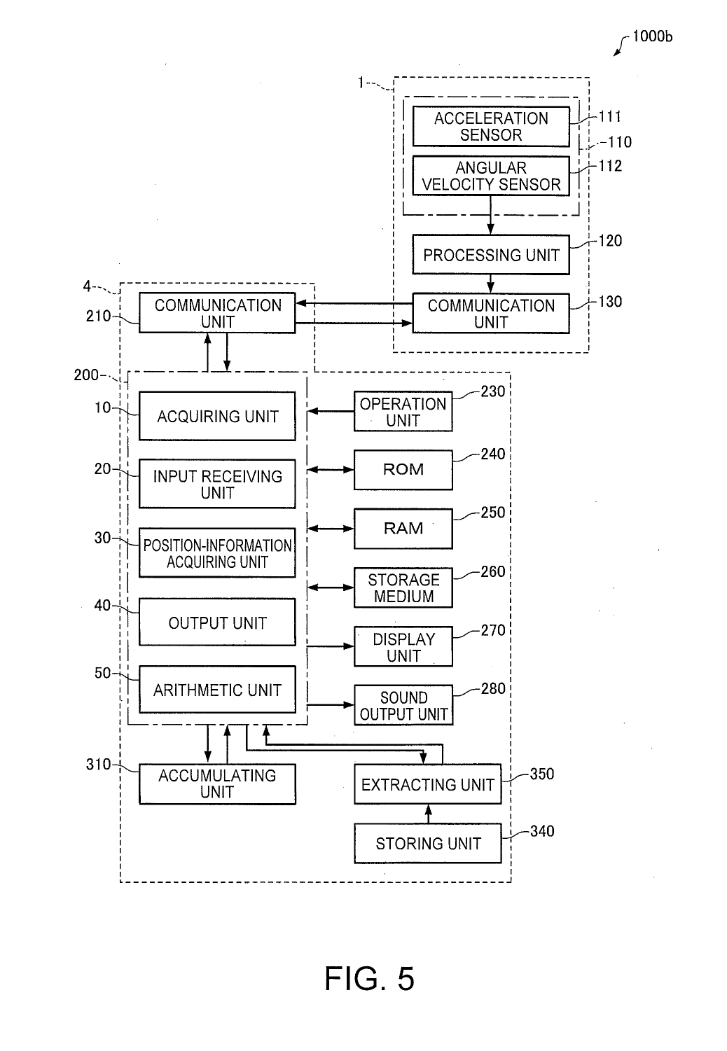

FIG. 5 is a block diagram showing a configuration example of an exercise information providing system 1000b according to the third embodiment. Components same as the components of the exercise information providing system 1000 according to the first embodiment are denoted by the same reference numerals and signs and detailed explanation of the components is omitted.

The exercise information providing system 1000b according to this embodiment includes the detecting device 1 and an information providing device 4.

The information providing device 4 includes the acquiring unit 10, the input receiving unit 20, the position-information acquiring unit 30, the output unit 40, the arithmetic unit 50, the accumulating unit 310, the storing unit 340, and the extracting unit 350. The accumulating unit 310 and the extracting unit 350 exchange data with the processing unit 200. The information providing device 4 may be, for example, a portable device such as a smart phone or a personal computer (PC).

The exercise information providing system 1000b according to the third embodiment attains effects same as the effects of the exercise information providing system 1000 according to the first embodiment because of the same reason.

### 2. Exercise Information Providing Method

### 2-1. First Embodiment

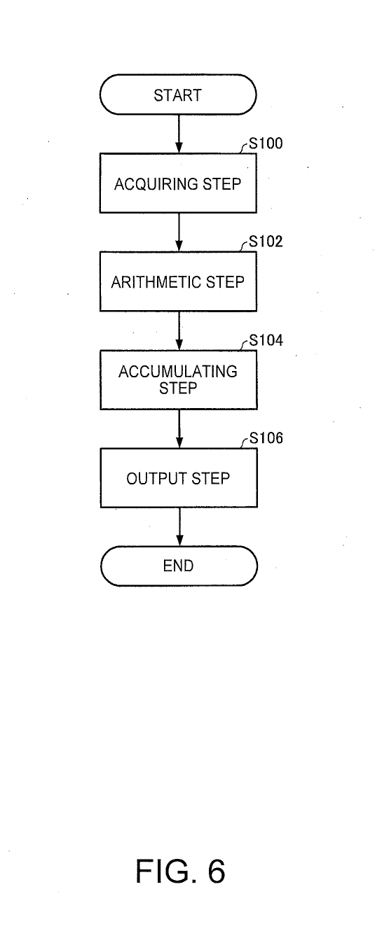

FIG. 6 is a flowchart for explaining an overview of an exercise information providing method according to the first embodiment. Note that not all of steps shown in FIG. 6 are essential components. In the following explanation, an example is explained in which the exercise information providing method according to the first embodiment is carried out using the exercise information providing system 1000.

The exercise information providing method according to this embodiment includes an acquiring step (step S100), an accumulating step (step S104), and an output step (step S106). The exercise information providing method according to this embodiment may further include an arithmetic step (step S102).

In the example shown in FIG. 6, first, the acquiring step (step S100) for acquiring the first exercise information, which is the information concerning the swing of the user 2001 in a first environment acquired from the detecting device 1 that detects a motion of the user 2001 swinging an exercise instrument (the golf club 2002) is performed. In this embodiment, the acquiring unit 10 of the terminal device 2 performs processing in step S100.

After step S100, the arithmetic step (step S102) for indexing the information concerning the swing acquired from the detecting device 1 and generating the first exercise information is performed. In this embodiment, the arithmetic unit 50 of the terminal device 2 performs processing in step S102.

After step S102, the accumulating step (step S104) for associating the first exercise information and environment information concerning a scene in which the first exercise information is acquired and accumulating the first exercise information and the environment information as first associated information is performed. In this embodiment, the accumulating unit 310 performs processing in step S104.

After step S104, the output step (step S106) for outputting the first associated information accumulated in the accumulating step (step S104) is performed. In this embodiment, the output unit 300 performs processing of step S106.

With the exercise information providing method according to this embodiment, the first exercise information, which is the information concerning the swing, acquired from the detecting device 1 that detects the motion of the user 2001 swinging the exercise instrument (the golf club 2002) is acquired. Therefore, it is possible to acquire information that is more easily compared with information concerning a swing acquired in another scene (a second environment) than images and videos of the exercise. The first exercise information accumulated in the accumulating unit 310 is output according to a request of the user 2001. Therefore, it is possible to realize the exercise information providing method that can provide the user 2001 with information concerning the motion of swinging the exercise instrument (the golf club 2002) even in a different scene (the second environment).

In the exercise information providing method according to this embodiment, in the acquiring step, second exercise information, which is information concerning a new swing in another scene (the second environment) by the user 2001, and environment information concerning the second environment may be acquired from the detecting device 1. In the accumulating step, second associated information obtained by associating the second exercise information and the environment information concerning the second environment may be accumulated in the server device 3. In the output step, the first associated information including the first exercise information accumulated in the accumulating step and the second associated information including the second exercise information acquired by the acquiring step may be output according to a request of the user 2001. For example, first associated information obtained by associating first exercise information concerning a swing in a golf course serving as the first environment and location information concerning the golf course and second associated information obtained by associating second exercise information concerning a swing in a practice area serving as the second environment and location information concerning the practice area are acquired and the information is accumulated in the server device 3.

According to this embodiment, for example, the first exercise information concerning the swing in the golf course and the second exercise information concerning the swing in the practice area are output. Therefore, it is possible to realize the exercise information providing method with which kinds of information concerning swings acquired in different scenes are easily compared.

In the exercise information providing method according to this embodiment, in the acquiring step, the second exercise information, which is information concerning a new swing in another scene (the second environment) by the user 2001, and environment information concerning the second environment may be acquired from the detecting device 1. In the output step, the first exercise information and the second exercise information accumulated in the accumulating step may be compared according to a request of the user 2001 and a comparison result may be output. For example, in the output step, a difference between the first exercise information and the second exercise information (e.g., a difference between head speed maximum values and a difference between angles of a face surface during impact) may be output.

According to this embodiment, the comparison result of the first exercise information and the second exercise information is output. Therefore, it is possible to realize the exercise information providing method with which information concerning exercise acquired in another scene and information concerning new exercise are easily compared. For example, first exercise information concerning a swing in a golf course serving as the first environment and environment information concerning the golf course and second exercise information concerning a swing in a practice area serving as the second environment and environment information concerning the practice area are accumulated in the server device 3. A difference between the first exercise information and the second exercise information is output to the user. Consequently, the user can recognize whether a difference occurs in the swings according to the different scenes (the golf course and the practice area).

### 2-2. Second Embodiment

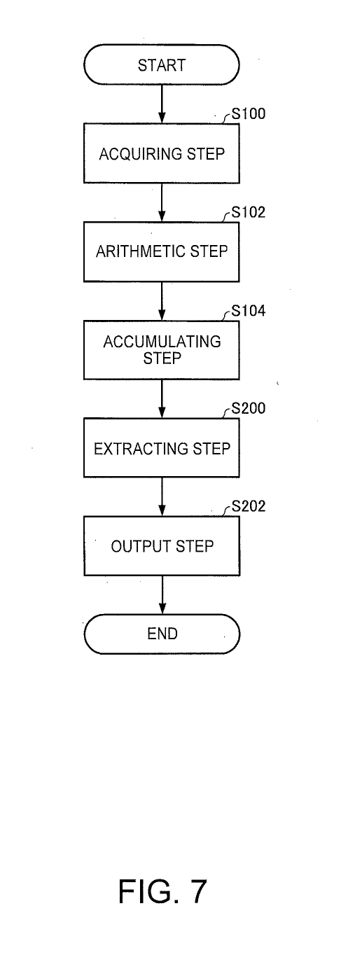

FIG. 7 is a flowchart for explaining an overview of an exercise information providing method according to the second embodiment. Note that not all of steps shown in FIG. 7 are essential components. In the following explanation, an example is explained in which the exercise information providing method according to the second embodiment is carried out using the exercise information providing system 1000. Note that steps same as the steps of the exercise information providing method according to the first embodiment are denoted by the same reference signs and detailed explanation of the steps is omitted.

The exercise information providing method according to this embodiment includes an acquiring step (step S100), an accumulating step (step S104), an extracting step (step S200), and an output step (step S202). The exercise information providing method according to this embodiment may further include an arithmetic step (step S102).

In the example shown in FIG. 7, after step S104, concerning each of a plurality of exercise instruments (golf clubs), the extracting step (step S200) for extracting exercise instrument information from the storing unit 340 that stores exercise instrument information, which is information concerning the exercise instruments (the golf clubs), is performed on the basis of the first exercise information accumulated in the accumulating step (step S104). In this embodiment, the extracting unit 350 of the server device 3 performs processing in step S200.

After step S200, the output step (step S202) for outputting the exercise instrument information extracted in the extracting step (step S200) is performed. In this embodiment, the output unit 300 of the server device 3 and the output unit 40 of the terminal device 2 perform processing in step S202.

According to this embodiment, the exercise instrument information is extracted from the storing unit 340 on the basis of the first exercise information accumulated in the accumulating step (step S104). Therefore, for example, it is possible to extract, on the basis of a tendency of the swing of the user 2001, information concerning an exercise instrument suitable for the swing of the user 2001.

### 3. Use Examples

The exercise information providing system and the exercise information processing method explained above can be used in various scenes. In the following explanation, use examples are explained in which the scene (the first environment) in which the first exercise information is acquired and the scene (the second environment) in which the first exercise information is output are different.

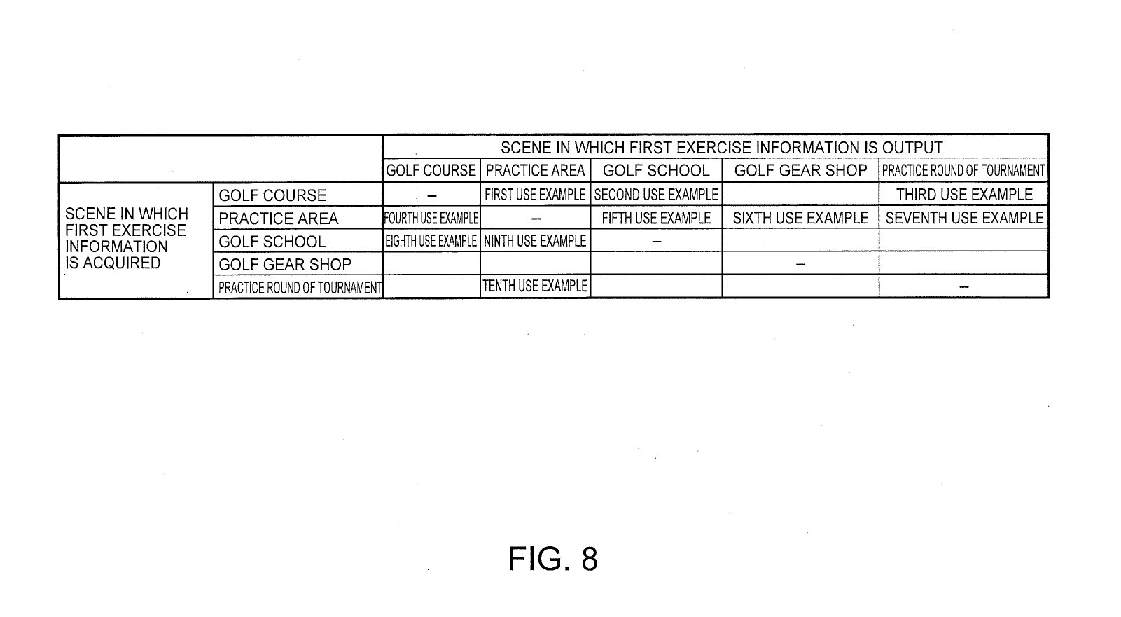

FIG. 8 is a table showing an overview of the use examples. In an example shown in FIG. 8, as examples of a scene in which the first exercise information is acquired and examples of a scene in which the first exercise information is output, a golf course, a practice area, a golf school, a golf gear shop, and a practice round of a tournament are shown.

### 3-1. First Use Example

A first use example is an example in which the first exercise information acquired in the golf course is output and used in the practice area.

The user can learn, on the basis of the first exercise information acquired in the golf course, weak points of the user such as a habit of a swing and a golf club of a number that the user has difficulty in handling. Therefore, the user can perform practices for overcoming the weak points in the practice area.

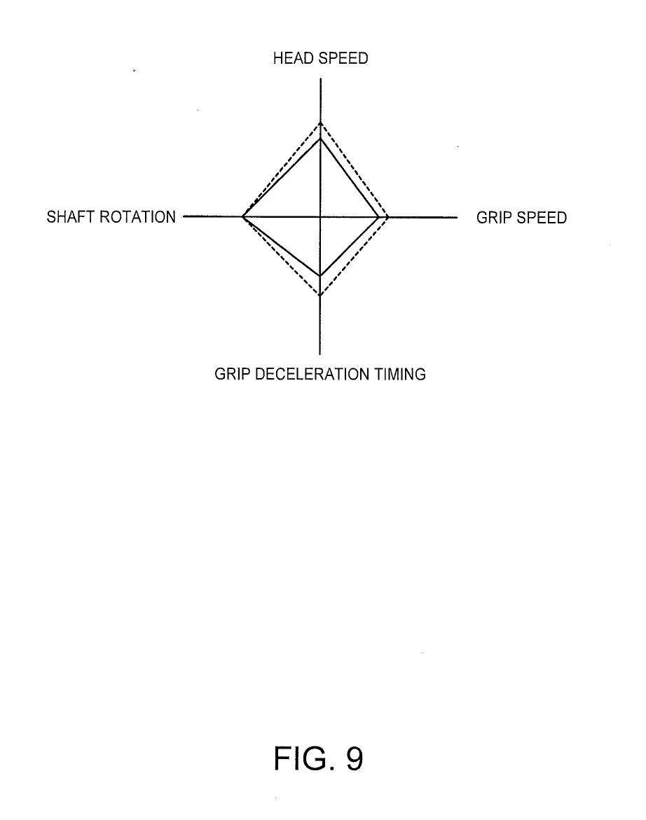

FIG. 9 is a diagram showing a display example of the first exercise information and the second exercise information. In a radar chart shown in FIG. 9, an item of “head speed” represents a maximum value of head speed during a swing period, an item of “grip speed” represents a maximum value of grip speed during the swing period, an item of “grip deceleration timing” represents timing when the grip speed takes the maximum value based on timing of impact, and an item of “shaft rotation” represents a change amount of a rotation angle of a shaft axis during the swing period. In the example shown in FIG. 9, an index concerning the first exercise information is indicated by a solid line and an index concerning the second exercise information is indicated by a dotted line.

As shown in FIG. 9, the user can learn effects of the practices by comparing the first exercise information acquired in the golf course and the second exercise information acquired in the practice area.

### 3-2. Second Use Example

A second use example is an example in which the first exercise information acquired in the golf course is output and used in the golf school.

The user can learn, on the basis of the first exercise information acquired in the golf course, weak points of the user such as a habit of a swing and a golf club of a number that the user has difficulty in handling. Therefore, the user can perform practices for overcoming the weak points in the golf school. By providing a coach in the golf school with the first exercise information acquired in the golf course, the user can receive appropriate advices from the coach. As shown in FIG. 9, the user can learn effects of the practices by comparing the first exercise information acquired in the golf course and the second exercise information acquired in the golf school.

### 3-3. Third Use Example

A third use example is an example in which the first exercise information acquired in the golf course is output and used in the practice round of the tournament.

The user can learn, on the basis of the first exercise information acquired in the golf course same as a golf course of the tournament, before a start of the tournament, points to which the user should pay attention in the present tournament.

### 3-4. Fourth Use Example

A fourth use example is an example in which the first exercise information acquired in the practice area is output and used in the golf course.

In an unofficial round, which is not a tournament and the like, the second exercise information can be acquired by attaching the detecting device 1 to a golf club. Therefore, as shown in FIG. 9, by comparing the first exercise information acquired in the practice area and the second exercise information acquired in the golf course, the user can check how a swing in the practice area and a swing in the golf course are different. Consequently, the user can reduce failures and immediately notice failures.

### 3-5. Fifth Use Example

A fifth use example is an example in which the first exercise information acquired in the practice area is output and used in the golf school.

The user can learn, on the basis of the first exercise information acquired in the practice area, weak points of the user such as a habit of a swing and a golf club of a number that the user has difficulty in handling. Therefore, the user can perform practices for overcoming the weak points in the golf school. By providing a coach in the golf school with the first exercise information acquired in the practice area, the user can receive appropriate advices from the coach. As shown in FIG. 9, the user can learn effects of the practices by comparing the first exercise information acquired in the practice area and the second exercise information acquired in the golf school.

### 3-6. Sixth Use Example

A sixth use example is an example in which the first exercise information acquired in the practice area is output and used in the golf gear shop.

By providing a store clerk in the golf gear shop with the first exercise information acquired in the practice area, the user can receive appropriate advices concerning selection of a golf club to be purchased. As shown in FIG. 9, the user can learn effects by use of a new golf club by comparing the first exercise information acquired in the practice area and the second exercise information acquired in the golf gear shop.

The user can also extract exercise instrument information on the basis of the first exercise information acquired in the practice area.

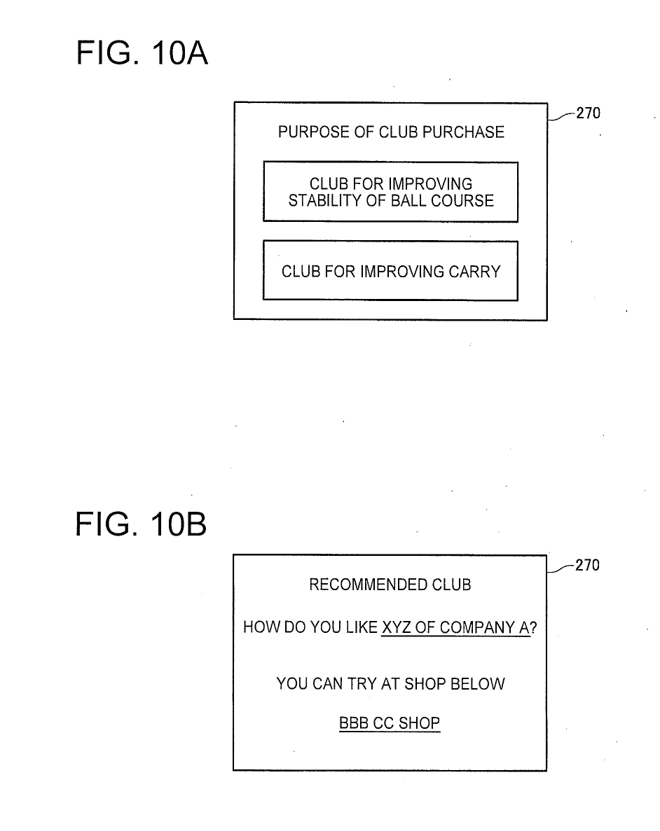

FIGS. 10A and 10B are diagrams showing display examples displayed when exercise instrument information is extracted. FIG. 10A is a display example showing a menu for causing the user to select a purpose of purchasing an exercise instrument (a golf club). FIG. 10B is a display example showing an extraction result of the exercise instrument information.

As shown in FIG. 10A, by causing the user to select a purpose of purchasing an exercise instrument (a golf club) and extracting exercise instrument information on the basis of information concerning the purpose of purchasing the exercise instrument (the golf club) and the first exercise information acquired in the practice area, it is possible to extract, on the basis of a tendency of a swing of the user, information concerning an exercise instrument (a golf club) suitable for the swing of the user. Consequently, it is possible to urge the user to purchase the exercise instrument (the golf club) suitable for the user.

As shown in FIG. 10B, the exercise information providing system may further output information concerning the golf gear shop that deals in the extracted exercise instrument (golf club). The exercise information providing system may extract the golf gear shop on the basis of position information acquired by the position-information acquiring unit 30. Consequently, it is possible to provide information useful for both of the user and the golf gear shop.

### 3-7. Seventh Use Example

A seventh use example is an example in which the first exercise information acquired in the practice area is output and used in the practice round of the tournament.

As shown in FIG. 9, the user can learn a condition and a swing tendency of the user before the start of the tournament by comparing the first exercise information acquired in the practice area and the second exercise information acquired in the practice round of the tournament. Therefore, it is possible to provide the user with information useful for improvement of achievement in the tournament.

### 3-8. Eighth Use Example

An eighth use example is an example in which the first exercise information acquired in the golf school is output and used in the golf course.

In an unofficial round, which is not a tournament and the like, the second exercise information can be acquired by attaching the detecting device 1 to a golf club. Therefore, as shown in FIG. 9, by comparing the first exercise information acquired in the golf school and the second exercise information acquired in the golf course, the user can check how a swing in the golf school and a swing in the golf course are different. Consequently, the user can reduce failures and immediately notice failures.

### 3-9. Ninth Use Example

A ninth use example is an example in which the first exercise information acquired in the golf school is output and used in the practice area.

As shown in FIG. 9, by comparing the first exercise information acquired in the golf school and the second exercise information acquired in the practice area, the user can check how a swing taught in the golf school and a swing in the practice area are different. Consequently, it is possible to provide the user with information useful for the user to perform practices to improve the swing in the practice area to be close to the swing taught in the golf school.

### 3-10. Tenth Use Example

A tenth use example is an example in which the first exercise information acquired in the practice round of the tournament is output and used in the practice area.

The user can learn, on the basis of the first exercise information acquired in the practice round of the tournament, weak points of the user such as a habit of a swing and a golf club of a number that the user has difficulty in handling. Therefore, the user can perform practices for overcoming the weak points in the practice area. Further, as shown in FIG. 9, the user can learn effects of the practices by comparing the first exercise information acquired in the golf course and the second exercise information acquired in the practice area.

The embodiments and the modifications explained above are examples. The invention is not limited to the embodiments and the modifications. For example, the embodiments and the modifications can also be combined as appropriate.

The invention includes components substantially the same as the components explained in the embodiments (e.g., components having the same functions, methods, and results or components having the same purposes and effects). The invention includes components in which unessential portions of the components explained in the embodiments are replaced. The invention includes components that attain action and effects same as the action and effects of the components explained in the embodiments or components that can attain purposes same as the purposes of the components explained in the embodiments. The invention includes components obtained by adding publicly-known techniques to the components explained in the embodiments.

The entire disclosure of Japanese Patent Application No. 2014-131611, filed Jun. 26, 2014 is expressly incorporated by reference herein.

What is claimed is:

1. An exercise information providing method comprising:
acquiring first exercise information based on an output from a detecting device output when a user performs exercise in a first environment and first environment information concerning the first environment;
associating the first exercise information and the first environment information and accumulating the first exercise information and the first environment information as first associated information; and
outputting the first associated information to a second environment.

2. An exercise information providing method comprising:
acquiring first exercise information based on an output from a detecting device output when a user performs exercise in a first environment and first environment information concerning the first environment;
associating the first exercise information and the first environment information and accumulating the first exercise information and the first environment information as first associated information;
acquiring second exercise information based on an output from the detecting device output when the user performs exercise in a second environment and second environment information concerning the second environment;
associating the second exercise information and the second environment information and accumulating the second exercise information and the second environment information as second associated information; and
outputting the first associated information and the second associated information.

3. The exercise information providing method according to claim 2, wherein the first exercise information included in the first associated information and the second exercise information included in the second associated information are compared to output a comparison result.

4. The exercise information providing method according to claim 1, wherein the first environment information includes at least one of position information, time information, and event information obtained when the exercise is performed.

5. The exercise information providing method according to claim 2, wherein the first environment information includes at least one of position information, time information, and event information obtained when the exercise is performed.

6. The exercise information providing method according to claim 2, wherein the second environment information includes at least one of position information, time information, and event information obtained when the exercise is performed.

7. The exercise information providing method according to claim 1, wherein the second environment is a place different from the first environment.

8. The exercise information providing method according to claim 2, wherein the second environment is a place different from the first environment.

9. The exercise information providing method according to claim 1, wherein
the exercise is exercise performed using an exercise instrument, and
information concerning the exercise instrument is output to the second environment on the basis of the first exercise information.

10. The exercise information providing method according to claim 7, wherein the second environment is a shop that sells the exercise instrument.

11. The exercise information providing method according to claim 1, wherein each of the first environment and the second environment is any one of a game venue, a practice area, a tournament, a school, and a shop.

12. The exercise information providing method according to claim 2, wherein each of the first environment and the second environment is any one of a game venue, a practice area, a tournament, a school, and a shop.

13. An exercise information providing system comprising:
an acquiring unit configured to acquire first exercise information based on an output from a detecting device output when a user performs exercise in a first environment and first environment information concerning the first environment;
an accumulating unit configured to associate the first exercise information and the first environment information and accumulate the first exercise information and the first environment information as first associated information; and
an output unit configured to output the first associated information to a second environment.

14. An exercise information providing system comprising:
an acquiring unit configured to acquire first exercise information based on an output from a detecting device output when a user performs exercise in a first environment, first environment information concerning the first environment, second exercise information concerning exercise performed by the user in a second environment, and second environment information concerning the second environment;
an accumulating unit configured to associate the first exercise information and the first environment information and accumulate the first exercise information and the first environment information as first associated information and associate the second exercise information and the second environment information and accumulate the second exercise information and the second environment information as second associated information; and
an output unit configured to output the first associated information and the second associated information.

15. The exercise information providing system according to claim 13, further comprising:
a terminal device including the acquiring unit; and
a server device including the accumulating unit and the output unit.

16. The exercise information providing system according to claim 14, further comprising:
a terminal device including the acquiring unit; and
a server device including the accumulating unit and the output unit.
